(19) United States
(12) Patent Application Publication
(10) Pub. No.: US 2009/0014991 A1
(43) Pub. Date: Jan. 15, 2009

(54) Gunner Retraction System and Apparatus

(76) Inventors: David Christopher Smyth, Baltimore, MD (US); Andrew Paul Smyth, Alexandria, VA (US); Christopher Charles Smyth, Fallston, MD (US)

Correspondence Address: U S ARMY RESEARCH LABORATORY;ATTN AMSRL CS CC IP, 2800 POWDER MILL RD, ADELPHI, MD, 207831197, US

(21) Appl. No.: 11/775,293

(22) Filed: Jul. 10, 2007

(51) Int. Cl. B60R 21/16

(52) U.S. Cl. 280/734

(57) ABSTRACT

A rollover protection system for protecting exposed gunners during ground vehicle rollovers. The system retracts the gunner into the vehicle thereby removing him/her from physical danger. The system apparatus comprises a safety harness for the gunner with a retraction mechanism that is activated upon vehicle rollover. The safety harness is attached by elastic runners to pre-loaded springs which are held in a tension mode by clamps. The springs are placed in enclosed containers mounted to the bay-floor of the vehicle. The spring clamps are released by a computer in response to a gyroscopic sensor. Shock-absorbing inflatable cushions attached to the floor under the gunner are activated to cushion the retraction.

### GOVERNMENT INTEREST

The embodiments described herein may be manufactured, used, and/or licensed by or for the United States Government without the payments of royalties thereon.

### BACKGROUND

1. Technical Field

The embodiments herein generally relate to vehicle-related systems, and, more particularly, to systems and devices used to protect vehicles during unintentional vehicle rollover.

2. Description of the Related Art

Some military ground vehicles such as armored convoy escort and utility trucks have an exposed gunner standing in the center of the vehicle with his/her upper torso above the cab who manually rotates the turret to align the gun with a target. A gunner-protection kit with side paneling is provided on some designs. The problem is that during evasive action on rough off-road terrain, the driver, in executing a tight turn at high speed, can roll the vehicle over. This action can inflict severe bodily harm resulting in the incapacitation or death of the gunner. This is the case for the armored HMMWV (High Mobility Multipurpose Wheeled Vehicle), and some variants of the Mine Resistant Ambush Protected (MRAP) armored vehicles, such as the RG-31 Charger armor protected vehicle, the RG-33 armor protected truck, and the Cougar mine protected troop transport vehicle, all being considered for augmenting and later replacing the HMMWV with improved armor and hull design.

Conventional systems comprise techniques that protect the gunner by maintaining the integrity of the gun-mount space. Generally, this is based on the use of mechanisms that may be cumbersome, difficult to maintain, and add extra weight and power drain to an overloaded frame. For example, one approach is to use a retractable roll bar such as those used on some ground vehicle cars and tractors that are activated in a rollover to protect the driver. This design could provide rollover protection of the gun-mount while allowing full coverage gunfire when in retraction. However, the armored M-114 HMMWV with payload can weigh over six tons and a suitable retractable roll bar of sufficient strength and speed of activation will likely be cumbersome, add extra weight, and require extensive maintenance to operate properly in a military environment. This is the case as well for the RG-31 Charger weighing 7.28 tons, the heavier RG-33, and the 12-ton Cougar.

Furthermore, during vehicle rollover, the gunner may still be partially ejected out of the gunner's hatch by the resulting centrifugal force and thereby be prevented from a rapid entry back into the vehicle crew compartment. This may result in the gunner being injured or killed by being crushed between the ground and the top of the vehicle possibly by the roll bar as well. While the automobile industry has developed systems such as those described in U.S. Pat. Nos. 6,038,495 and 6,850,824 including inflatable air bags to prevent head injuries and restraint systems to prevent ejection from vehicles during rollover, these systems only apply to occupants fully seated and secured inside of the vehicle, and usually only the front seat of the vehicle. That is, in a typical vehicle (non-military), an occupant is in a secured position, and as such, a typical airbag protects an occupant that is already in a secured position. However, such systems would be impractical in a military ground vehicle with an exposed gunner who is not in a secured position and not in the front of the vehicle because he has at least a portion of his body outside of the vehicle and cannot use a traditional seatbelt to secure himself to the vehicle. In other words, a gunner in a military vehicle is not restrained by conventional seatbelts, and thus is not protected during rollover. Thus, the gunner must be retracted from harm (i.e., retracted from outside the vehicle to inside the vehicle) during rollover. Additionally, conventional systems are meant to prevent a vehicle occupant from being thrust from inside the vehicle. However, if an occupant is already partially outside of the vehicle, then the conventional systems will not sense that there is an occupant in the vehicle and in the event of a rollover, the restraint systems will not likely deploy, and accordingly, will not retract the occupant back inside the vehicle. Moreover, a conventional airbag absorbs the energy of a rollover (or impact); it does not absorb the energy of the retraction of the occupant.

Recognizing this problem, the United States Army has developed a restraining harness for the gunner to prevent ejection; however, the gunner is expected to pull himself back into the vehicle during rollover, a difficult maneuver to perform in the presence of the centrifugal force. Accordingly, in view of the drawbacks and limitations of the conventional solutions there remains a need for a mechanism that protects the exposed gunner during ground vehicle rollovers. The mechanism should provide stability to the gunner's position during operations over rough terrain and high-speed maneuvers as well as prevent ejection and aid in retraction during rollovers.

### SUMMARY

In view of the foregoing, an embodiment herein provides a gunner rollover protection system for a ground vehicle comprising a vehicle frame; a harness capable of being worn by a user; an elastic runner connected to the harness; a ball-in-socket joint connected to the elastic runner; a retraction device operatively connected to the ball-in-socket joint, wherein the retraction device comprises springs operatively connected to the vehicle frame, wherein the springs are held in tension by a clamp; a spring clamp release mechanism connected to the retraction device and adapted to release the clamp; a shock absorbing inflatable cushion connected to the harness; an inflator adapted to inflate the shock absorbing inflatable cushion; an attitude sensor operatively connected to the inflator and adapted to sense the attitude of the vehicle; and a retraction controller connected to each of the spring clamp release mechanism and the inflator, wherein the retraction controller is adapted to track the attitude of the vehicle using the attitude sensor and activate the spring clamp release mechanism and the inflator.

Preferably, in the retraction controller, retraction is activated via short-range radio transmission from a transponder with input from the retraction controller to a receiver with output to the inflator. Moreover, the retraction controller comprises a microcomputer comprising a central processing unit (CPU); a read only memory (ROM) connected to the CPU, wherein the ROM comprises a computer program of instructions functioning as an operating system executable by the CPU; a random access memory (RAM) cache connected to the CPU, wherein the RAM is adapted to store an attitude tracking history; an analog-to-digital converter (ADC) connected to the CPU, wherein the ADC is adapted to digitize the output of the attitude sensor, an output of the spring clamp release mechanism, and an output of the inflator.

Furthermore, the ADC may comprise a control line input from the CPU, an analog line input from the attitude sensor, and a digital line output to the CPU; the ROM may comprise a control line input from the CPU, and a digital line output to the CPU, wherein the CPU is adapted to read program instructions from the computer program; the RAM may comprise a control line input from the CPU, and a digital line output to the CPU, wherein the CPU is adapted to read and write digital data for random address storage; and the CPU may comprise control line outputs to the spring clamp release mechanism and the inflator. Additionally, the computer program of instructions is adapted to perform a method of operating the retraction controller, wherein the method comprises receiving an attitude of the vehicle; updating an attitude history of the vehicle; computing a rollover likelihood of the vehicle and a roll rate of the vehicle; and determining whether the vehicle is in a state of rollover. Furthermore, when the vehicle is in the state of rollover, the method may further comprise activating control signals to the spring clamp release mechanism and the inflator. Also, the attitude sensor may comprise a gyroscopic sensor.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIGS. 1(A) and 1(B) are schematic diagram illustrating an application for a gunner rollover protection system according to the embodiments herein;

FIG. 2(A) illustrates a schematic diagram of a retraction system according to the embodiments herein;

FIG. 2(B) illustrates a schematic diagram of a retraction system during combat operations according to the embodiments herein;

FIG. 2(C) illustrates a schematic diagram of a retraction system during roll-over according to the embodiments herein;

FIG. 3(A) illustrates a schematic diagram of the retraction device of FIGS. 2(A) through 2(C) according to the embodiments herein;

FIG. 3(B) illustrates a schematic diagram of an alternate embodiment of the retraction device of FIGS. 2(A) through 2(C) according to the embodiments herein;

FIGS. 3(C) through 3(E) illustrate schematic diagrams of alternate embodiments depicting activation control according to the embodiments herein;

FIG. 3(F) through 3(H) illustrate schematic diagrams of alternate embodiments of the sensing device of FIGS. 2(A) through 2(C) according to the embodiments herein;

FIG. 4 illustrates a schematic diagram of a controller for the retraction system of FIGS. 2(A) through 2(C) according to the embodiments herein;

FIG. 5 is a flow diagram illustrating a preferred method according to the embodiments herein; and

FIG. 6 is a schematic diagram illustrating a computer system according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

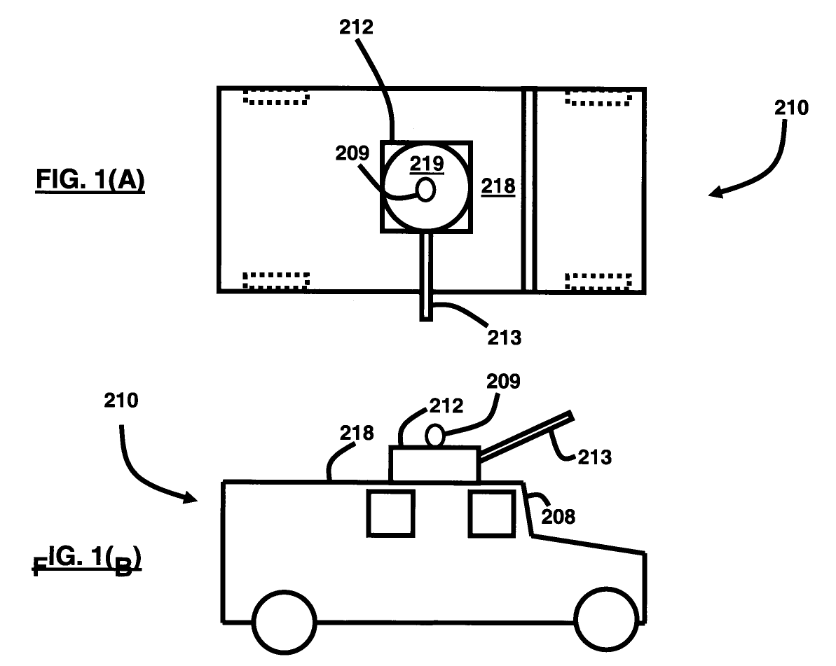

As mentioned, there remains a need for a mechanism that protects exposed gunners during ground vehicle rollovers. The embodiments herein achieve this by providing a gunner retraction system that includes a safety harness that retracts the gunner into the vehicle thereby removing him from physical danger and is activated upon vehicle rollover. Referring now to the drawings, and more particularly to FIGS. 1(A) through 6, where similar reference characters denote corresponding features consistently throughout the figures, there are shown preferred embodiments.

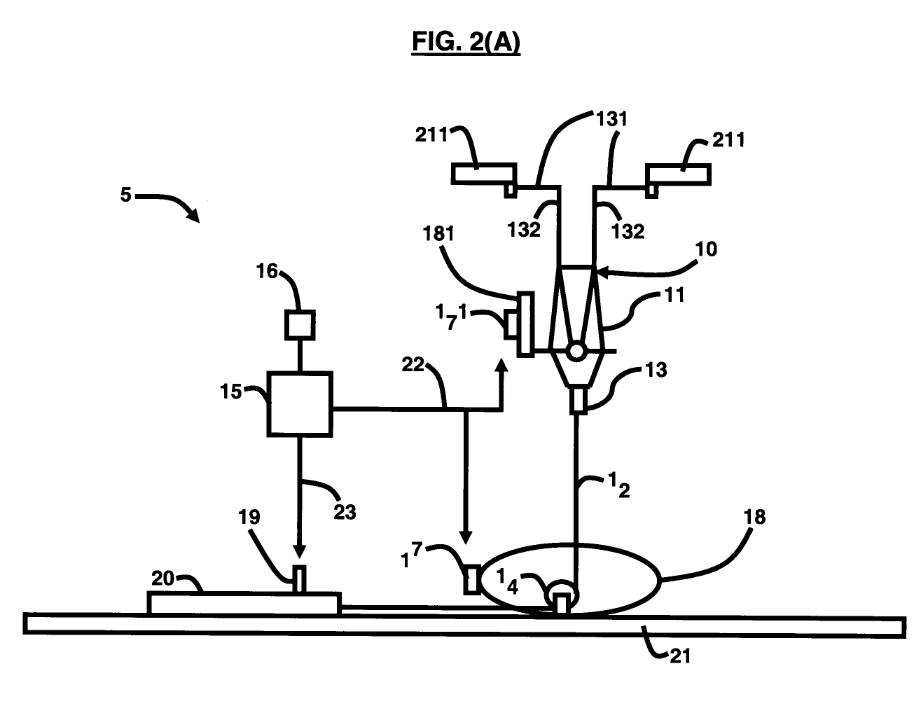

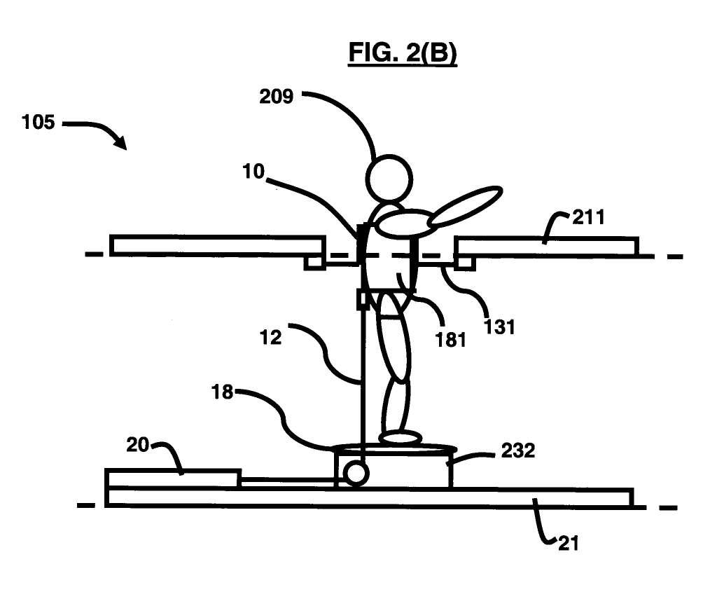

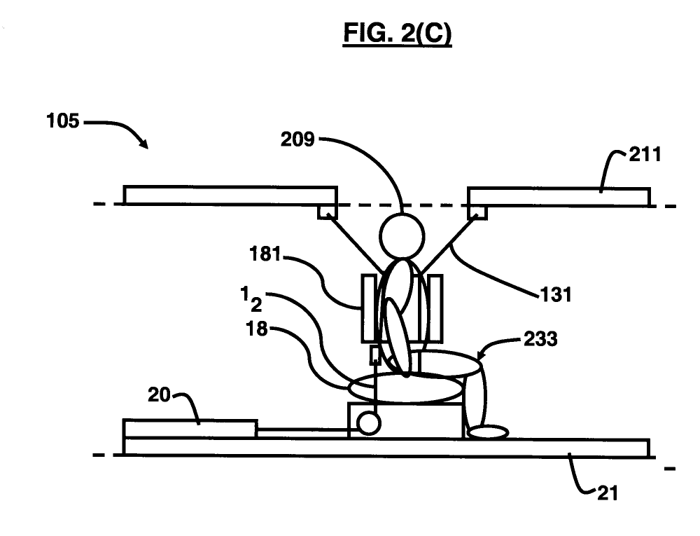

The embodiments herein provide a rollover protection system that has applications to armored vehicles 210 such as the up-armored M-114 or M-116 HMMWV illustrated in FIGS. 1(A) and 1(B), where the gunner 209 operates a gun 213, such as an M2 50-caliber machine gun, mounted on a traversing turret mechanism 219 from a roof mounted gun cupola 211 (shown in FIGS. 2(A) through 2(C)) located on top 218 of the vehicle 210. The gunner 209 stands in the center of the vehicle 210 with his upper torso above the cab 208 and manually rotates the turret 219 to align the gun 213 with a target (not shown). A gunner protection kit 212 with side paneling may be provided. However, one problem is that during evasive action on rough off-road terrain, the driver, in executing a tight turn at a high speed, can roll the vehicle 210 over.

FIG. 2(A), with reference to FIGS. 1(A) and 1(B), illustrates a gunner retraction system 5 according to an embodiment herein. The gunner retraction system 5 comprises a safety harness 10 operatively connected to a retraction device 20 that is activated upon rollover of the vehicle 210. The safety harness 10 is worn by a gunner 209 and in one embodiment has webbing straps 11 configured over the shoulders of a gunner 209 in a pattern across the chest and back and attached to the webbing straps 11 at the waist of the gunner 209. The ends of the safety harness 10 are attached by elastic shock absorbing lanyards 12 through a swivel or ball-in-socket joint 13 to the retraction device 20 via a pulley system 14. In turn, the top of the safety harness 10 is attached to the vehicle roof mounted gun cupola 211 by suspension lines 131 via webbing risers 132. Attached to the harness 10 is an inflatable, wearable air bag vest 181, with inflator 171 for protecting the user's head, neck, spine, and waist during retraction. Moreover, the harness includes a quick-release rotary buckle (not shown) for emergency release from the retraction system 5.

Preferably, the retraction device 20 is embodied as an energy storage unit attached to the frame 21 of the vehicle 210 operating as an actuator with a release mechanism 19 for retraction of the lanyards 12. A floor mounted air bag or cushion 18 for absorbing the shock of the retraction to prevent injury to the gunner 209 and an inflator 17 is also provided. The system 5 includes a sensing device 16 for determining the occurrence of a rollover event, a retraction controller 15 activated upon rollover, a communication mechanism 22 for the controller 15 to communicate commands to the inflator 17 (and inflator 171), and a communication mechanism 23 for the controller 15 to communicate commands to the actuator release mechanism 19.

FIG. 2(B) illustrates another embodiment of a gunner retraction system 105 during normal combat operations. The gunner 209 is shown standing at the vehicle roof mounted gun cupola 211 on an adjustable platform 232 at the gun position with a collapsed cushion 18. Similarly, the air cushion vest 181 on the harness 10 is collapsed. The suspension lines 131 and attached risers 132 (best shown in FIG. 2(A)) are fastened together so as not to interfere with the manual operations. Similarly, the lanyards 12 operatively connected to the retraction device 20 are under minimal tension.

In contrast, FIG. 2(C) illustrates the retraction system 105 following completion of retraction. Here, the gunner 209 is shown having been retracted by the activation of the retraction device 20 into a seated position in the vehicle 210 (of FIGS. 1(A) and 1(B)) with the initial force being absorbed by the lanyards 12. The cushion 18 is inflated to absorb the force of the retraction and in the process forcing the gunner's legs 233 outward to prevent injury. At the same time, the cushion vest 181 is inflated to prevent body injury which could result from striking the interior of the vehicle 210 during the rollover event. The suspension lines 131 having been pulled from the risers 132 fastened on the harness 10 suspend the gunner 209 from the roof mounted gun cupola 211. The gunner 209 is in a stable and protected position as the vehicle 210 rolls over regardless of the orientation of the vehicle 210. The gunner 209 can release himself once the vehicle 210 has come to a stop with the harness quick release buckle (not shown).

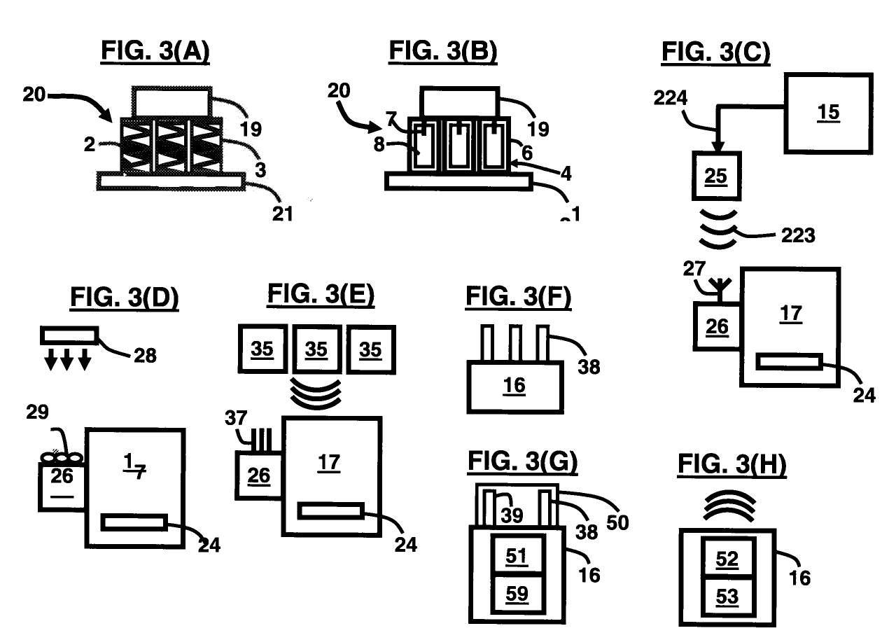

One embodiment shown in FIG. 3(A) for the retraction device 20 comprises pre-loaded mechanical coiled compression springs 2, which are preferably enclosed in a mechanical guide 3 to prevent axial buckling, and are attached to the vehicle frame 21 and held in tension by the release mechanism 19. Upon release, the springs 2, in response to the release of the compression force, expand to retract the lanyards 12. In a variation, the retraction device 20 may use mechanical extension (pulling force) or torsion (twisting force) springs 2.

In another embodiment illustrated in FIG. 3(B), the retraction device 20 comprises a gas spring 4 with compressed air or nitrogen gas that has a controlled rate of expansion, thereby providing damping at the end of the actuation stroke. The gas spring 4 comprises cylinders 6 having a rod 7 and piston 8 that are chargeable with air or nitrogen resulting in stored energy; upon release of the clamping force, the compressed gas expands causing the piston 8 to retract the lanyards 12.

In still another embodiment, the retraction device 20 comprises a methanol-powered titanium-nickel flat wire coil (not shown) that is coated with a platinum catalyst for a methanol fuel and air mixture; the heat produced by the oxygen and hydrogen combustion at the wire surface causes the coil to contract and shorten thereby retracting the lanyards 12. The fuel mixture is sprayed into the spring housing (not shown) upon activation of the retracting action. The contraction rate is controlled by the mixture of oxygen and methanol in the spray and the period of contraction by duration of injection; natural cooling allows the spring (not shown) to lengthen to remove the retraction force on the user once rollover is completed.

In still another embodiment, the retraction device 20 comprises an electroactive polymer plastic that changes shape with electrical activation; in particular, the ionic electroactive polymers, such as the ionomeric (ion-exchange membrane) polymer-metallic composites (IPMC) that expand in an electrochemical response to electrical activation as a result of the mobility of cations in the hydrated polymer network. The approximately 10 volts of voltage required to activate the polymer is supplied by the vehicle electrical system upon activation of the retracting action and results in a large amplitude bending movement (strain level of approximately 200%) with sufficient force applied in a relatively gradual manner on the order of fractions of a second. The bending moment causes the retraction of the lanyards 12.

Continuing with embodiments, the retraction device 20 comprises an ionic electroactive polymer made from carbon nanotubes suspended in an electrolyte that expands upon the injection of an electric charge into the nanotubes in the presence of a platinum catalyst. The voltage required to activate the polymer is supplied by the vehicle electrical system upon activation of the retraction action and the resulting expansion causes the retraction of the lanyards 12.

Again with respect to FIG. 2(A), in a further embodiment, an air bag or cushion 18 is used to absorb the shock of retraction to prevent the gunner 209 from striking the inside of the vehicle 210 with, in particular, his head or back, or preventing dislocation of a limb. While in automobiles, front and side curtain and tubular air bags are inflated for use in protecting the head and chest in front and side collisions; however, the air bag or cushion 18 used in the embodiments herein is intended to protect the back, including the head and spine, of the gunner 209. An attached inflator mechanism 17 is used to inflate the cushions 18. Furthermore, an igniter 24 (as shown in FIGS. 3(C) through 3(E)) in the inflator mechanism 17 produces nitrogen or argon gas from a chemical reaction that quickly inflates the cushion 18.

In one embodiment, the air bag may be embodied as a shock-absorbing inflatable cushion vest 181 that is attached to the safety harness 10 and is worn by the gunner 209 as a deflated vest 181 on his back and underneath his seat. In another embodiment, the deflated cushions 18 are in the form of a floor mat that is attached to the floor of the vehicle 210 near the position of the gunner 209, and is inflated at retraction to form an energy-absorbing cushion 18. The cushion 18, when inflated, both absorbs the shock of the retraction and guides the legs 233 forward to prevent injury. In a further embodiment, the shock-absorbing cushions are shape-memory polymers that, stowed in a compact form, recover the pre-pressed shape under the heat induced by the inflator chemical reaction; these materials can inflate to a volume change of over forty times the pressed size.

The retraction controller 15, preferably embodied as a microcomputer, tracks the attitude of the vehicle 210 and controls gunner retraction, with input from the attitude sensor 16, and sends an activation output control signal (via communication mechanism 23) to the release mechanism 19 and the control signal (via communication mechanism 22) to the cushion inflator mechanism 17. In one embodiment, the output control signal (via communication mechanism 22) to the cushion inflator mechanism 17 is wirelessly activated by a short-range radio transmission 223 from a transponder 25 (shown in FIG. 3(C)) with input 224 from the retraction controller 15 to a receiver 26 (shown in FIG. 3(C)) with output to the cushion inflator mechanism 17 to allow the gunner 209 free rotation in movement. The radio signal sent by the transponder 25 is typically approximately one milliwatt for safety and at a relatively low 125 kHz frequency to reduce interference.

The receiver 26 may be a passive device with an antenna 27 energized by the radio transmission to activate noise suppression techniques that reduce interference from reflections and other sources. The transponder 25 may be located on the ceiling near the position of the gunner 209 and the receiver 26 may be located adjacent to the inflator mechanism 17 to facilitate transmission since the radio waves can be sent through and around the human body, clothing, and other non-metallic materials. In another embodiment as depicted in FIG. 3(D), the activation is optical where a pulsing wide-angle infrared emitter 28 such as a Light Emitting Diode (LED) 28 is used to illuminate a set of infrared sensors 29 mounted on the receiver 26 located adjacent to the inflator mechanism 17. The illumination is line-of-sight and the emitter 28 and sensors 29 should preferably be facing each other. The sensor input is threshold-limited to preclude any signal noise that is generated by other light sources within the vehicle 210.

In still another embodiment as shown in FIG. 3(E), the activation is ultrasonic where an array of pulsing ultrasonic transmitters 35 is used to radiate sound pulses to an array of microphones 37 on a receiver 26 at the inflator mechanism 17. The sensor input is threshold-limited to preclude any signal noise that is generated by vibrations within the vehicle 210. The transmission is line-of-sight and the transmitters 35 and receivers 26 should preferably be facing each other. In other embodiments, the same techniques described here may be used to send an activation output control signal (via communication mechanism 23) to the release mechanism 19.

A further embodiment is the sensing device 16 used to determine the occurrence of a rollover event for activation of the retraction controller 15. In this embodiment, the sensing device 16 is embodied as an attitude sensor 16 that is mounted in the vehicle 210, and in one embodiment shown in FIG. 3(F), the attitude sensor 16 comprises an attitude reference gyroscope 38 used to measure the pitch, roll, and yaw attitude angles of the vehicle 210. Preferably, the attitude sensor 16 comprises three orthogonal gyroscopes 38 integrated to form an orthogonal three axes unit system, wherein each gyroscope 38 is adapted to measure the rotating rate or whole angle displacement based on the Coriolis effect, with a rotation about one axis generating a force in an orthogonal direction when the center of mass vibrates in the third direction.

In a variation of this embodiment, the gyroscopes 38 are embodied as a microelectromechanical system (MEMS) employing miniature vibrating structures such as quartz and silicon vibrating beams, tuning forks, vibrating beams, vibrating shells, or piezoelectric vibrating devices. Preferably, the attitude sensor 16 is mounted on top of the vehicle 210 in proximity to the position of the gunner 209 for maximum sensitivity to the rotational forces that would be experienced in a vehicle rollover situation.

In a further embodiment shown in FIG. 3(G), the sensing device 16 comprises a micro inertial measurement device 50 comprising both micro gyroscopes 38 and accelerometers 39 to perform integrated measurements of the six dimensional movement parameters. The three orthogonal accelerometers 39 (only one accelerometer 39 is illustrated in FIG. 3(G) for clarity) measure accelerations in the Cartesian coordinate linear dimensions while the gyroscopes 38 (only one gyroscope 38 is illustrated in FIG. 3(G) for clarity) measure the pitch, yaw, and roll movements about those dimensions. The linear velocity and displacement are determined from the integrated acceleration and the attitude from the rotational velocity relative to fixed coordinates. The micro inertial measurement device 50 may include a cantilever beam with a fixed end and a cantilevered end on a proof mass; the movement of the proof end indicates acceleration. Other variations may be piezoresistive (piezoresistive resistance in cantilevered beam), capacitive (proof mass middle of opposite electrode plates), resonant, thermal, optical, electromagnetic, or tunneling current. In this embodiment, the sensing device 16 forms an integrated combination of micro accelerometers 39, gyroscopes 38, signal processing circuits 51, and signal conditioning circuits 59 to provide six inertia parameters in real time for the attitude and displacement of the vehicle 210.

A still further embodiment of the sensing device 16 as illustrated in FIG. 3(H) includes a Global Positioning System (GPS) satellite receiver 52 and processor 53 used to reset the inertial measurements which tend to drift over time. Although the GPS receiver 52 measures real time position and attitude, the GPS satellite signal is extremely weak and is difficult to receive when under trees and near buildings that can block satellite transmissions. Preferably, the GPS receiver 52 is roof-mounted in the vehicle 210 to maximize satellite coverage.

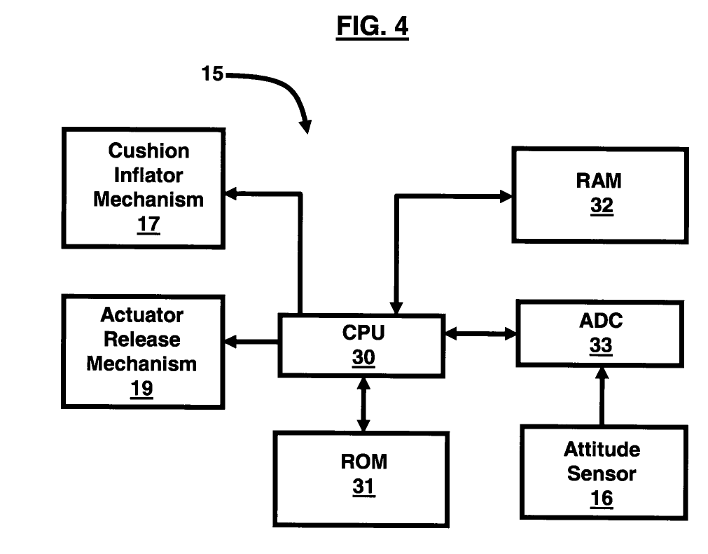

FIG. 4 illustrates the retraction controller 15 of FIG. 2(A) in greater detail. The retraction controller 15 comprises a central processing unit (CPU) 30, with digital data and control lines operatively connected to a read-only memory (ROM) 31 with stored processing instructions constituting an operating system, and to a random-access memory (RAM) cache 32 for storing the attitude tracking history. The CPU 30 also has digital data and control lines to an analog-to-digital converter (ADC) 33. Moreover, the ADC 33 has an electrical analog input from the output of the attitude sensor 16. In addition, the CPU 30 has output control lines to generate the control signal (via communication mechanism 23) to the release mechanism 19 and to generate the control signal (via communication mechanism 22) to the cushion inflator mechanism 17.

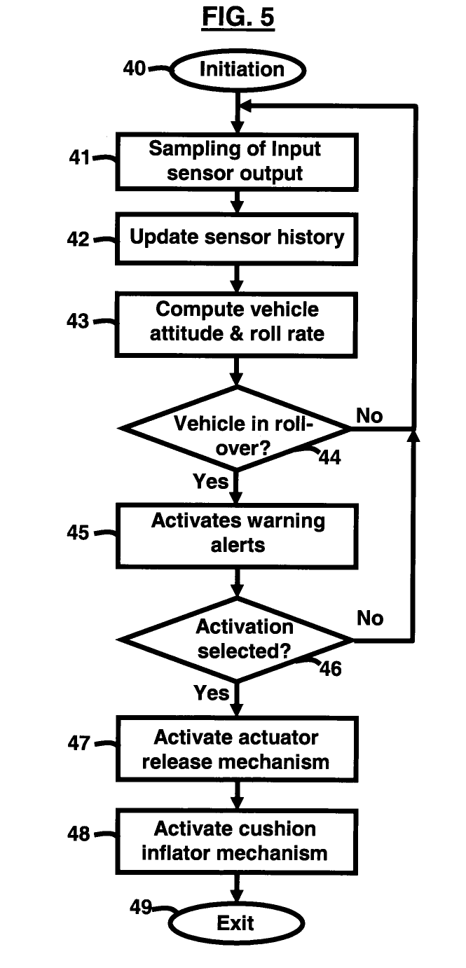

FIG. 5, with reference to FIGS. 1(A) through 4, illustrates a flowchart for operation of a computer program implemented by the CPU 30 of FIG. 4. Following initiation (40), the CPU 30 samples (41) the output of the attitude sensor 16, updates (42) the time-wise attitude history, and computes (43) the attitude and roll rate. In a further embodiment, a non-linear filter (not shown), such as an extended Kalman filter, is used to estimate the current roll attitude from the updated history of the sensor readings, and predict the future roll attitude from the estimated current roll attitude and sensed roll rate for use in computing the rollover status.

The inputs to the filter are the vehicle accelerations and velocities in the Cartesian coordinate linear dimensions (as defined by the vehicle body 210), as well as the pitch, yaw, and roll movements about these dimensions. Preferably, the Kalman filter is a single lag order and the size of the attitude tracking history is determined by the number of filter state variables. In the context of the embodiments herein, the filter state variables are the inputs to the filter, which the filter uses to compute the rollover state of the vehicle 210. The filter state variables comprise the accelerations and velocities in the Cartesian coordinate linear dimensions (as defined by the body of the vehicle 210). Additionally, the filter state variables include the pitch, yaw, and roll movements about these dimensions. In another embodiment using an autoregressive moving average filter (ARMA), the history size is determined by the number of filter state variables and the filter order. Here, the filters may be embodied as part of the computer operating system stored on the ROM 31 (of FIG. 4). Next, the rollover mode of the vehicle 210 is evaluated (44) by comparing the output of the filter to a threshold value. If the vehicle 210 is not in the rollover mode (No), then the methodology returns to the start of the computer program and continues through the process once again. Conversely, if the vehicle 210 is in the rollover mode (Yes), then the CPU 30 activates (45) a warning alert to the crew, checks for selection of a roll over activation response (46), and if such, activates (47) the actuator release mechanism 19 and activates (48) the cushion inflator mechanism 17 by sending output signals to each, and then exits (49) the computer program, but if not, continues to test the vehicle rollover status.

In one embodiment, the warning alert (45) to the crew is a synthetic speech “roll-over alert” message repeatedly spoken over the vehicle intercom (not shown). The warning is intended to give the crew time to prepare for the occurrence. In such an embodiment, the gunner 209 may use a toggle switch (not shown) at his station to set the activation selection functionality (46) allowing him to override the retraction until he judges it necessary. An indicator light (not shown) at the switch provides feedback on the status of the retraction functionality. In another embodiment, the vehicle crew chief may use an embedded keypad interface (not shown) to preset the activation selection functionality (46) through the CPU 30 allowing gunner control or not depending on the mission as determined by the tactical environment.

The retraction controller 15 comprises both hardware and software elements. The embodiments of the software elements include, but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a RAM 32, a ROM 31, a rigid magnetic disk and an optical disk. Current examples of optical disks include compact disk-read only memory (CD-ROM), compact disk-read/write (CD-R/W) and DVD.

A data processing system suitable for storing and/or executing program code includes at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

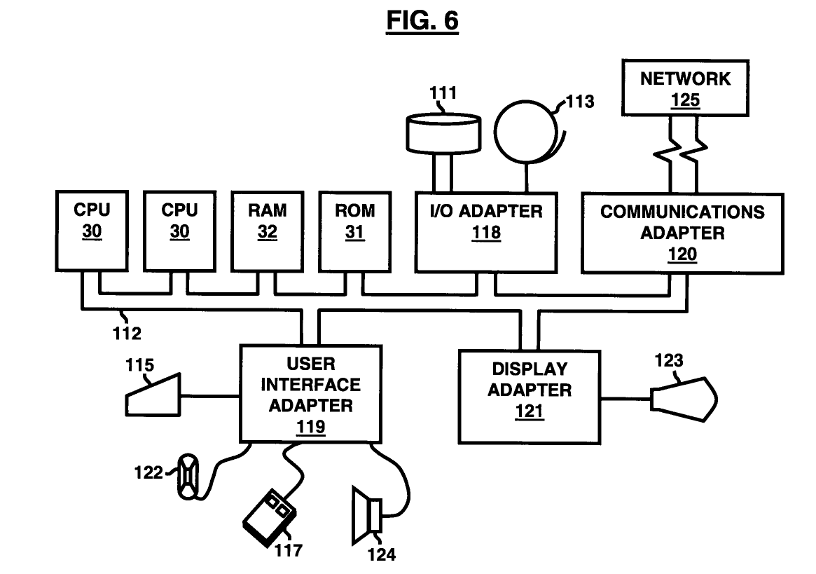

A representative hardware environment for practicing the embodiments herein is depicted in FIG. 6. This schematic drawing illustrates a hardware configuration of an information handling/computer system in accordance with the embodiments herein. The system comprises at least one processor or CPU 30. The CPUs 30 are interconnected via system bus 112 to various devices such as a RAM 32, ROM 31, and an I/O adapter 118. The I/O adapter 118 can connect to peripheral devices, such as disk units 111 and tape drives 113, or other program storage devices that are readable by the system. The system can read the inventive instructions on the program storage devices and follow these instructions to execute the methodology of the embodiments herein. The system further includes a user interface adapter 119 that connects a keyboard 115, mouse 117, speaker 124, microphone 122, and/or other user interface devices such as a touch screen device (not shown) to the bus 112 to gather user input. Additionally, a communication adapter 120 connects the bus 112 to a data processing network 125, and a display adapter 121 connects the bus 112 to a display device 123 which may be embodied as an output device such as a monitor, printer, or transmitter, for example.

The embodiments herein provide several advantages including the use of technology that is affordable and readily applied to armored HMMWV or MRAP vehicles 210 with or without gunner protection kits and shields 212, and provides a system 5, 105 that causes no significant reduction in the current performance and stability characteristics of up-armored HMMWV or MRAP vehicles 210, causes little impact on the gunner's operations, and provides survivable space for the gunner 209 during a rollover event.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A gunner rollover protection system for a military ground vehicle to protect a user who is at least partially positioned outside of the vehicle from physical trauma incurred from rollover of said vehicle, the system comprising:
a sensor adapted to sense impending vehicle rollover;
an energy storage device mounted within said vehicle that upon activation retracts said user to an inside of said vehicle;
an attachment worn by said user and operatively connected to said energy storage device;
a shock absorber that upon activation inflates to absorb the energy of retraction of said energy storage device once said user is inside said vehicle;
a shock absorber inflator; and
a controller that once said sensor senses impending vehicle rollover, activates said energy storage device and said shock absorber inflator.

2. The rollover protection system of claim 1, wherein said energy storage device comprises any of a set of pre-loaded mechanical coiled, compression, extension, and torsion springs held in tension by a clamp.

3. The rollover protection system of claim 1, wherein said energy storage device comprises a set of gas springs with any of compressed air and nitrogen gas, and a piston held in a tension state by a clamp.

4. The rollover protection system of claim 1, wherein said energy storage device comprises any of an electroactive polymer and metallic compound activated by an electrochemical reaction induced by the application of an electric charge.

5. The rollover protection system of claim 1, wherein said attachment comprises a harness worn by said user with elastic lanyards connected to said energy storage device.

6. The rollover protection system of claim 1, wherein said shock absorber comprises any of an inflatable cushion and an air-bag operatively connected to one of said attachment and said vehicle and positioned proximate to said user, that upon activation is inflated by an inflator mechanism comprising an igniter producing any of nitrogen and argon gas from a chemical reaction that inflates said cushion and then releases the gas following retraction.

7. The rollover protection system of claim 1, wherein retraction is activated via short range radio transmission from a transponder with input from said controller to a receiver with output to said shock absorber inflator.

8. The rollover protection system of claim 1, wherein retraction is activated via an ultrasonic acoustic signal from an array of pulsing ultrasonic transmitters with input from said controller to an array of microphones with output to said shock absorber inflator.

9. The rollover protection system of claim 1, wherein retraction is activated via an optical signal from an array of pulsing wide-angle infrared light emitting diodes with input from said controller that illuminates a set of infrared sensors with output to said shock absorber inflator.

10. The rollover protection system of claim 1, further comprising an attitude sensor comprising an attitude reference gyroscope comprising a plurality of orthogonal gyroscopes forming an orthogonal multi-axes unit system to measure pitch, roll, and yaw attitudes of said vehicle.

11. The rollover protection system of claim 1, further comprising an attitude sensor comprising a micro inertial measuring device comprising micro gyroscopes and accelerometers in a microelectromechanical system performing integrated measurements of the six dimensional parameters of linear and rotational movements.

12. The rollover protection system of claim 1, further comprising an attitude sensor comprising a Global Positioning System (GPS) satellite receiver and processor to perform integrated measurements of the linear dimensions and reset inertial measurements.

13. The rollover protection system of claim 1, wherein said controller comprises a microcomputer further comprising:
a central processing unit (CPU);
a read only memory (ROM) operatively connected to said CPU, wherein said ROM comprises a computer program of instructions functioning as an operating system executable by said CPU;
a random access memory (RAM) cache operatively connected to said CPU, wherein said RAM is adapted to store an attitude tracking history; and
an analog-to-digital converter (ADC) operatively connected to said CPU, wherein said ADC is adapted to digitize an output of said shock absorber inflator.

14. The rollover protection system of claim 13, wherein said computer program of instructions is adapted to perform a method of operating said controller, said method comprising:
receiving an attitude of said vehicle;
updating an attitude history of said vehicle;
computing a rollover likelihood of said vehicle and a roll rate of said vehicle; and
determining whether said vehicle is in a state of rollover.

15. The rollover protection system of claim 14, wherein the computation of a rollover likelihood is performed by a non-linear filter used to estimate a current roll attitude from the updated attitude history, and predict a future roll attitude from estimated current roll attitude readings and sensed roll rate readings for use in computing a rollover status,
wherein inputs to the filter comprise vehicle accelerations and velocities in Cartesian coordinate linear dimensions, and pitch, yaw, and roll movements about said Cartesian coordinate linear dimensions,
wherein a size of said attitude history is determined by a number of filter state variables and a filter order, and
wherein a rollover state of said vehicle is evaluated by comparing an output of said filter to a threshold value.

16. The rollover protection system of claim 14, wherein when said vehicle is in said state of rollover, said method further comprises activating control signals to said shock absorber inflator.

17. A gunner rollover protection system for a military ground vehicle to protect a gunner in a position extended outside of the vehicle from physical trauma resulting from rollover of said vehicle, the system comprising:
a vehicle frame;
a harness capable of being worn by said gunner while positioned partially outside of said vehicle;
an elastic runner operatively connected to said harness;
a ball-in-socket joint operatively connected to said elastic runner;
a retraction device operatively connected to said ball-in-socket joint, wherein said retraction device comprises any of spring and gas pistons operatively connected to said vehicle frame, wherein any of said springs and gas pistons are held in tension by a clamp;
a spring clamp release mechanism operatively connected to said retraction device and adapted to release said clamp;
a shock absorbing inflatable cushion operatively connected to any of said harness and a floor of said vehicle;
an inflator adapted to inflate said shock absorbing inflatable cushion;
an attitude sensor operatively connected to said inflator and said retraction device, wherein said attitude sensor is adapted to sense an attitude of said vehicle; and
a retraction controller operatively connected to said spring clamp release mechanism and said inflator, wherein said retraction controller is adapted to track said attitude of said vehicle using said attitude sensor and activate said spring clamp release mechanism and said inflator.

18. The gunner rollover protection system of claim 17, wherein said retraction controller comprises a microcomputer further comprising:
a central processing unit (CPU);
a read only memory (ROM) operatively connected to said CPU, wherein said ROM comprises a computer program of instructions functioning as an operating system executable by said CPU;
a random access memory (RAM) cache operatively connected to said CPU, wherein said RAM is adapted to store an attitude tracking history; and
an analog-to-digital converter (ADC) operatively connected to said CPU, wherein said ADC is adapted to digitize said output of said attitude sensor, an output of said clamp release mechanism, and an output of said inflator.

19. The gunner rollover protection system of claim 18, wherein said computer program of instructions is adapted to perform a method of operating said retraction controller, said method comprising:
receiving an attitude of said vehicle;
updating an attitude history of said vehicle;
computing a rollover likelihood of said vehicle and a roll rate of said vehicle; and
determining whether said vehicle is in a state of rollover.

20. The gunner rollover protection system of claim 19, wherein when said vehicle is in said state of rollover, said method further comprises activating control signals to said clamp release mechanism and said inflator.
